(19) United States
(12) Patent Application Publication
(10) Pub. No.: US 2014/0304639 A1
(43) Pub. Date: Oct. 9, 2014

(54) ELECTRONIC DEVICE AND METHOD FOR TRIGGERING EVENTS OF THE ELECTRONIC DEVICE

(71) Applicant: FIH (Hong Kong) Limited, Kowloon (HK)

(72) Inventor: WEN-SHIAN HUANG, New Taipei (TW)

(73) Assignee: FIH (HONG KONG) LIMITED, Kowloon (HK)

(21) Appl. No.: 14/226,607

(22) Filed: Mar. 26, 2014

(30) Foreign Application Priority Data
Apr. 3, 2013 (TW) 102112250

(51) Int. Cl. G06F 3/0488; G06F 3/0484

(52) U.S. Cl. CPC G06F 3/04886; G06F 3/0484
USPC 715/773

(57) ABSTRACT

In a method for triggering events of an electronic device, one or more events of the electronic device are set through a user interface, and a key combination for each of the events is received from the user interface. The key combination includes one or more distance sensors and a hot key of the electronic device. The method determines whether one of the distance sensors detects a user's finger in an effective sensing range when the hot key is approached by the user's finger. When one of the distance sensors detects the user's finger in the effective sensing range, the method triggers an event of the electronic device corresponding to the hot key, and executes a specified function of the hot key according to the event. If no distance sensor detects the user's finger in the effective sensing range, the method executes an inherent function of the hot key.

### FIELD

Embodiments of the present disclosure relate to program management systems and methods, and particularly to a electronic device and a method for triggering events of the electronic device.

### BACKGROUND

A variety of electronic devices, such as mobile terminals (e.g., cell phones, personal digital assistants (PDAs) and/or laptop computers), include touch screens. These touch screens are relied upon for data input and manipulation. Typically, an electronic device may generate and enable one or more soft keys displayed on a display screen. Each soft key includes an image (e.g., a button graphic) that is displayed on the display screen and touchable by users. The soft key is activated and one more actions or events of the electronic device are executed when the region of the soft key is touched by the users. However, it is inconvenient to touch a proper soft key to trigger an action or event since the soft keys are displayed on the touch screen in a small size. Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device comprising an event triggering system.

FIG. 2 is a block diagram illustrating function modules of the event triggering system included in the electronic device.

FIG. 3 is a flowchart of one embodiment of a method for triggering events of the electronic device.

FIG. 4 is a schematic diagram illustrating one embodiment of distance sensors positioned on the electronic device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium comprise CDs, DVDs, flash memory, and hard disk drives.

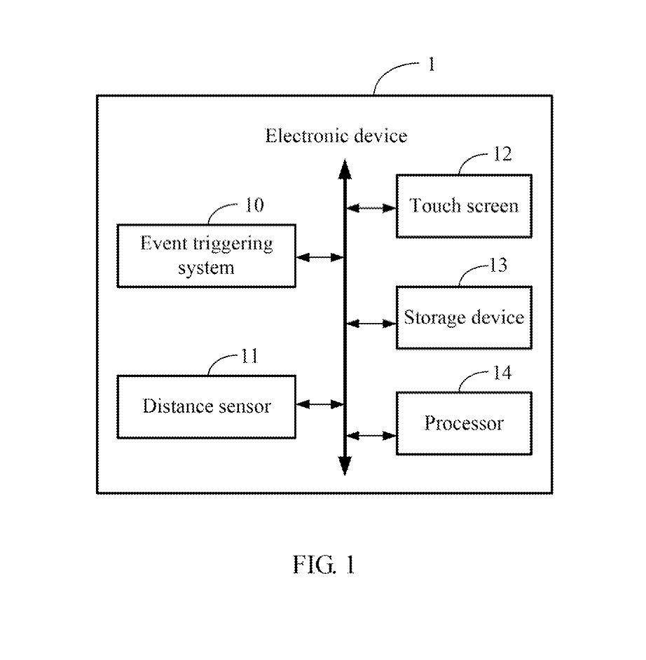

FIG. 1 is a block diagram of one embodiment of an electronic device 1 comprising an event triggering system 10. In the embodiment, the electronic device 1 further comprises, but is not limited to, one or more distance sensors 11, a touch screen 12, a storage device 13, and at least one processor 14. In one embodiment, the electronic device 1 can be a mobile phone, a personal digital assistant (PDA) device, a laptop computer, a media player, or a digital camera, for example. FIG. 1 is only one example of the computing device 1, and other examples may comprise more or fewer components than those shown in the embodiment, or have a different configuration of the various components.

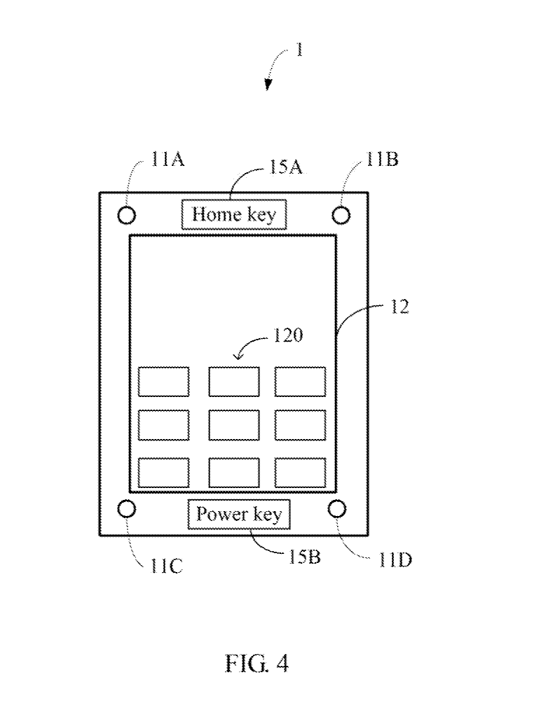

In the embodiment, the one or more distance sensors 11 can be positioned on different frontal panel edges of the electronic device 1. In one example with respect to FIG. 4, four distance sensors 11A, 11B, 11C, and 11D are included in the electronic device 1, and each of the distance sensors 11 is positioned on a vertex angle of the electronic device 1. When a hand of the user approaches one of the distance sensors 11, the distance sensor 11 can detect the user's hand, and an event of the electronic device 1 can be triggered by the event triggering system 10. In one embodiment, the event can be dialing a phone call, opening a phone book, playing music, or invoking a specific function of the electronic device 1.

Referring to FIG. 4, the touch screen 12 can display a plurality of display soft keys 120 generated by an application software of the electronic device 1. Each of the soft keys 120 can be touchable by the user's finger, and triggers a corresponding event of the application software. In the embodiment, the application software may be a game application, a music application, a phone application, or other applications of the electronic device 1.

In one embodiment, the storage device 13 can be an internal storage system, such as a flash memory, a random access memory (RAM) for temporary storage of information, and/or a read-only memory (ROM) for permanent storage of information. The storage device 13 can also be an external storage system, such as an external hard disk, a storage card, or a data storage medium. The at least one processor 14 can be a central processing unit (CPU), a microprocessor, or other suitable data processor chip that performs various functions of the electronic device 1.

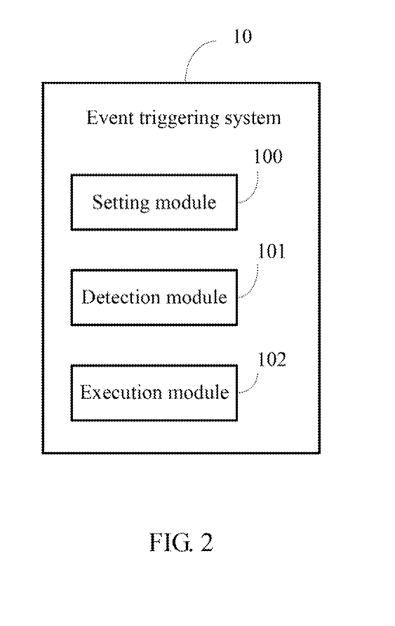

FIG. 2 is a block diagram illustrating function modules of the event triggering system 10 included in the electronic device 1 of FIG. 1. In the embodiment, the event triggering system 10 comprises, but is not limited to, a setting module 100, a detection module 101, and an execution module 102. The modules 101-102 can comprise computerized instructions in the form of one or more computer-readable programs that are stored in a non-transitory computer-readable medium (such as the storage device 13 of FIG. 1) and executed by the at least one processor 14 of the electronic device 1. A description of each module is given in the following paragraphs.

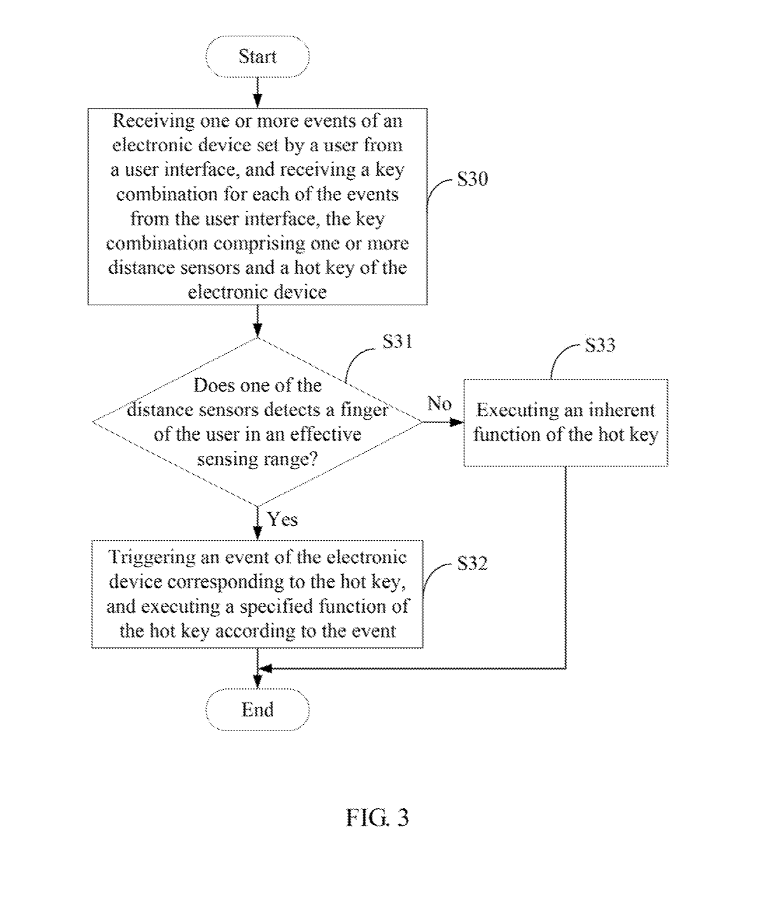

FIG. 3 is a flowchart of one embodiment of a method for triggering events of the electronic device 1. In the embodiment, the method is performed by execution of computer-readable software program codes or instructions by the at least one processor 14 of the electronic device 1. Depending on the embodiment, additional steps may be added, others removed, and the ordering of the steps may be changed.

In step S30, the setting module 100 displays a user interface on the touch screen 12 when an application software of the electronic device 1 is started, receives one or more events of the electronic device 1 set by a user from the user interface, and receives a key combination for each of the events from the user interface. In the embodiment, the application software may be a game application, a music application, a phone application, or other user application of the electronic device 1. The events can be dialing a phone call, opening a phone book, playing music, or invoking a specific function of the electronic device 1.

In one embodiment, the key combination includes one or more distance sensors 11 and a hot key of the electronic device 1. Referring to FIG. 4, the hot key can be a button key of the electronic device 1 or one of the soft keys 120 displayed on the touch screen 12. The button key can be a home key 15A or a power key 15B, for example. The soft keys 120 are generated by the application software, and may include a volume key, a confirm key, and a back key, for example. In the embodiment, four distance sensors 11A, 11B, 11C, and 11D are positioned on the vertex angles of the electronic device 1. If the user sets a combination of the home key 15A and the distance sensor 11A as the key combination, the event corresponds to opening a phone book of the electronic device 1.

In step S31, the detection module 101 determines whether one of the distance sensors 11 detects a finger of the user (hereinafter “user's finger”) in an effective sensing range when the hot key is approached by the user's finger. In the embodiment, the effective sensing range can be defined as distance range that can detect the user's finger. The sensing range can be a circle having radius with 10 cm, for example. If one of the distance sensors 11 detects the user's finger in the effective sensing range, step S32 is implemented. Otherwise, if no distance sensor 11 detects the user's finger in the effective sensing range, step S33 is implemented.

In step S32, the execution module 102 triggers an event of the electronic device 1 corresponding to the hot key, and executes a specified function of the hot key according to the event. In the embodiment, the specified function of the hot key is a function that is specified by the application software. For example, if the application software is a phone application, the specified function of the hot key is performed to open a phone book of the electronic device 1. If the key combination includes the home key 15A and the distance sensor 11A, and the distance sensor 11A detects that the user's finger approaches to the home key 15A, the event is triggered to open the phone book of the electronic device 1.

In step S33, the execution module 102 executes an inherent function of the hot key. In the embodiment, the inherent function of the hot key is a function that is specified by a manufactory of the electronic device 1. For example, if the distance sensor 11A does not detect that the user's finger approaches to the home key 15A, the electronic device 1 returns to a main menu of the electronic device 1 for the user. This function is the inherent function of the home key 15A that is specified by the manufactory of the electronic device 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor; and
a storage device storing a computer-readable program comprising instructions that, which when executed by the at least one processor, causes the at least one processor to:
receive one or more events of the electronic device from a user interface, and receive a key combination for each of the events from the user interface, the key combination comprising one or more distance sensors and a hot key of the electronic device;
determine whether one of the distance sensors detects a user's finger in an effective sensing range when the hot key is approached by the user's finger; and
trigger an event of the electronic device corresponding to the hot key and execute a specified function of the hot key according to the event, if one of the distance sensors detects the user's finger in the effective sensing range; or
execute an inherent function of the hot key when no distance sensor detects the user's finger in the effective sensing range.

2. The electronic device according to claim 1, wherein the user interface is displayed on a touch screen of the electronic device when an application software of the electronic device is started.

3. The electronic device according to claim 2, wherein the hot key is a button key of the electronic device or a soft key that is generated by the application software and displayed on the touch screen.

4. The electronic device according to claim 2, wherein the specified function of the hot key is a function that is specified by the application software.

5. The electronic device according to claim 2, wherein the inherent function of the hot key is a function that is specified by a manufactory of the electronic device.

6. The electronic device according to claim 1, wherein each of the distance sensors is positioned on a vertex angle of the electronic device.

7. A method for triggering events of an electronic device, the method comprising:
receiving one or more events of the electronic device from a user interface, and receiving a key combination for each of the events from the user interface, the key combination comprising one or more distance sensors and a hot key of the electronic device;
determining whether one of the distance sensors detects a user's finger in an effective sensing range when the hot key is approached by the user's finger; and
triggering an event of the electronic device corresponding to the hot key and executing a specified function of the hot key according to the event, if one of the distance sensors detects the user's finger in the effective sensing range; or
executing an inherent function of the hot key, if no distance sensor detects the user's finger in the effective sensing range.

8. The method according to claim 7, wherein the user interface is displayed on a touch screen of the electronic device when an application software of the electronic device is started.

9. The method according to claim 8, wherein the hot key is a button key of the electronic device or a soft key that is generated by the application software and displayed on the touch screen.

10. The method according to claim 8, wherein the specified function of the hot key is a function that is specified by the application software.

11. The method according to claim 8, wherein the inherent function of the hot key is a function that is specified by a manufactory of the electronic device.

12. The method according to claim 7, wherein each of the distance sensors is positioned on a vertex angle of the electronic device.

13. A non-transitory storage medium having stored thereon instructions that, when executed by at least one processor of an electronic device, causes the processor to perform a method for triggering events of the electronic device, the method comprising:
receiving one or more events of the electronic device from a user interface, and receiving a key combination for each of the events from the user interface, the key combination comprising one or more distance sensors and a hot key of the electronic device;
determining whether one of the distance sensors detects a user's finger in an effective sensing range when the hot key is approached by the user's finger; and
triggering an event of the electronic device corresponding to the hot key and executing a specified function of the hot key according to the event, if one of the distance sensors detects the user's finger in the effective sensing range; or
executing an inherent function of the hot key, if no distance sensor detects the user's finger in the effective sensing range.

14. The storage medium according to claim 13, wherein the user interface is displayed on a touch screen of the electronic device when an application software of the electronic device is started.

15. The storage medium according to claim 14, wherein the hot key is a button key of the electronic device or a soft key that is generated by the application software and displayed on the touch screen.

16. The storage medium according to claim 14, wherein the specified function of the hot key is a function that is specified by the application software.

17. The storage medium according to claim 14, wherein the inherent function of the hot key is a function that is specified by a manufactory of the electronic device.

18. The storage medium according to claim 13, wherein each of the distance sensors is positioned on a vertex angle of the electronic device.
